(19) United States
(12) Patent Application Publication
(10) Pub. No.: US 2008/0260892 A1
(43) Pub. Date: Oct. 23, 2008

(54) Animal Feed

(75) Inventor: Rae Fisher, Listowel (CA)

Correspondence Address: STANDLEY LAW GROUP LLP, 495 METRO PLACE SOUTH, SUITE 210, DUBLIN, OH, 43017, US

(73) Assignee: FISHER FEEDS LIMITED, Listowel (CA)

(21) Appl. No.: 11/995,739

(22) PCT Filed: Jul. 15, 2005
(86) PCT No.: PCT/CA2005/001109

§ 371 Date: Jun. 25, 2008

(30) Foreign Application Priority Data
Jul. 22, 2005 (JP) 2005-212537

(51) Int. Cl. A23K 1/00; A23K 1/18; A23L 1/27

(52) U.S. Cl. 426/2; 426/61; 426/540; 426/442

(57) ABSTRACT

Colored animal feeds, especially red and blue feeds, promote weight gain in animals, particularly poultry and swine. Colored feeds particularly promote weight gain in the first seven days leading to much improved weight at shipping. A concentrate having from about 1 wt % to about 15 wt % of a physiologically acceptable feed consumption enhancing food-coloring agent compatible with animal feed ingredients, from about 2 wt % to about 20 wt % of a physiologically acceptable electrolyte compatible with animal feed ingredients, and balance a physiologically acceptable carrier can be conveniently used to prepare colored animal feed on an industrial scale at any of various points in the milling or post-milling process.

### FIELD OF THE INVENTION

The present invention is related to animal feed, particularly to poultry and swine feed.

### DESCRIPTION OF RELATED ART

It is generally known in the art that color affects feeding behavior of animals. Several scientific and anecdotal studies have demonstrated that color is a stimulus for feed consumption, both alone and in combination with other factors. However, despite the body of knowledge on the effects of color and colored feed on feeding behaviour, attempts at efficiently incorporating color into animal feed, particularly on a large scale, especially in a feed mill, have been largely unsuccessful. Thus, there remains a need for colored animal feed, ways to color animal feed efficiently, and large-scale processes for coloring animal feed, especially in a feed mill.

### SUMMARY OF THE INVENTION

According to a first aspect of the invention, there is provided a concentrate for preparing a colored animal feed comprising: from about 1 wt % to about 15 wt % of a physiologically acceptable feed consumption enhancing food-coloring agent compatible with animal feed ingredients; from about 2 wt % to about 20 wt % of a physiologically acceptable electrolyte compatible with animal feed ingredients; and, balance a physiologically acceptable carrier, all weights based on weight of the concentrate.

According to a second aspect of the invention, there is provided a process for preparing colored animal feed, the process comprising: providing a concentrate having from about 1 wt % to about 15 wt % of a physiologically acceptable feed consumption enhancing food-coloring agent compatible with animal feed ingredients, from about 2 wt % to about 20 wt % of a physiologically acceptable electrolyte compatible with the animal feed ingredients and balance a physiologically acceptable carrier, all weights based on weight of the concentrate; mixing the concentrate with animal feed ingredients; and, further processing the mixture into colored animal feed.

According to a third aspect of the invention, there is provided a process for preparing colored animal feed, the process comprising: providing a concentrate having from about 1 wt % to about 15 wt % of a physiologically acceptable feed consumption enhancing food-coloring agent compatible with animal feed ingredients, from about 2 wt % to about 20 wt % of a physiologically acceptable electrolyte compatible with the animal feed ingredients and balance a physiologically acceptable carrier, all weights based on weight of the concentrate; mixing the concentrate with animal feed ingredients at a mixer in a feed mill where most of the animal feed ingredients are mixed; and, further processing the mixture into colored animal feed.

According to a fourth aspect of the present invention, there is provided a process for preparing colored animal feed, the process comprising: mixing animal feed ingredients to form a mash; applying a concentrate to the mash before pelletizing the mash, the concentrate having from about 1 wt % to about 15 wt % of a physiologically acceptable feed consumption enhancing food-coloring agent compatible with the animal feed ingredients, from about 2 wt % to about 20 wt % of a physiologically acceptable electrolyte compatible with the animal feed ingredients and balance a physiologically acceptable carrier, all weights based on weight of the concentrate; pelletizing the mash to form colored pellets; and, further processing the colored pellets into colored animal feed.

According to a fifth aspect of the present invention, there is provided a process for preparing colored animal feed, the process comprising: mixing animal feed ingredients to form a mash; pelletizing the mash to form pellets; applying a concentrate to the pellets to form colored pellets, the concentrate having from about 1 wt % to about 15 wt % of a physiologically acceptable feed consumption enhancing food-coloring agent compatible with the animal feed ingredients, from about 2 wt % to about 20 wt % of a physiologically acceptable electrolyte compatible with the animal feed ingredients and balance a physiologically acceptable carrier, all weights based on weight of the concentrate; and, further processing the colored pellets into colored animal feed.

According to a sixth aspect of the invention, there is provided a colored animal feed comprising: about 30-40 wt % corn, about 10-30 wt % wheat, about 10-15 wt % soya bean, about 5-10 wt % canola, about 0.05-0.25 wt % of a physiologically acceptable mineral, about 0.01-0.05 wt % of a physiologically acceptable enzyme, a physiologically acceptable feed consumption enhancing food-coloring agent and a physiologically acceptable electrolyte, all weights based on weight of the animal feed.

According to a seventh aspect of the invention, there is provided a method for enhancing consumption of animal feed by an animal, the method comprising: mixing a concentrate with a physiological acceptable diluent to form a mixture, the concentrate having from about 1 wt % to about 15 wt % of a physiologically acceptable feed consumption enhancing food-coloring agent compatible with animal feed ingredients, from about 2 wt % to about 20 wt % of a physiologically acceptable electrolyte compatible with animal feed ingredients and balance a physiologically acceptable carrier, all weights based on weight of the concentrate; applying the mixture to animal feed to form colored animal feed; drying the colored animal feed; providing the colored animal feed to the animal; and, allowing the animal to eat the colored animal feed.

According to a eighth aspect of the invention, there is provided a method of increasing weight gain of an animal, the method comprising: preparing a colored animal feed from a concentrate, the concentrate having from about 1 wt % to about 15 wt % of a physiologically acceptable feed consumption enhancing food-coloring agent compatible with the animal feed ingredients; from about 2 wt % to about 20 wt % of a physiologically acceptable electrolyte compatible with the animal feed ingredients; and, balance a physiologically acceptable carrier, all weights based on weight of the concentrate; and, feeding the colored animal feed to the animal.

### Concentrates:

Food-coloring agents used in concentrates of the present invention are physiologically acceptable insofar as they do not cause undue adverse reactions in an animal at amounts typically consumed by the animal eating a feed prepared using the concentrate. Furthermore, the food-coloring agent is compatible with animal feed ingredients insofar as the coloring agent does not react with other feed ingredients to unduly produce undesirable side-products. Preferably, the food-coloring agent can be mixed with the animal feed ingredients in a generally uniform manner. Preferably, the food-coloring agent is approved for use in animal feeds by the pertinent regulatory body of the state in which the feed is to be used.

The color of the food-coloring agent is one that enhances consumption of animal feed by the animal. Preferably, the color is red or blue, more preferably red. Colors can have different shades, tones and/or tints and the shades, tones and tints of a color included in the scope of that color. Some shades of red include, for example, scarlet, crimson, vermilion, carmine, maroon, burgundy, ruby, rose, madder, rouge, brick, blood red, blush, fire engine red, cinnabar, russet, rust, Venetian red, flame, Indian red and tomato. Some shades of blue include, for example, azure, cerulean, cobalt, cornflower blue, denim, dodger blue, International Klein blue, midnight blue, navy blue, periwinkle, powder blue, Prussian blue, royal blue, steel blue and ultramarine blue. A particularly preferred example of a red food-coloring agent is FD & C Red #40 dye. Mixtures of food-coloring agents may be used.

The food-coloring agent is present in the concentrate in an amount of from about 1 wt % to about 15 wt % based on the weight of the concentrate. Preferably, the amount of food-coloring agent is from about 2 wt % to about 10 wt %. An amount of from about 3 wt % to about 7 wt % is of particular note.

Electrolytes used in concentrates are physiologically acceptable insofar as they do not cause undue adverse reactions in an animal at amounts typically consumed by the animal eating a feed prepared using the concentrate. Furthermore, the electrolyte is compatible with animal feed ingredients insofar as the electrolyte does not react with other feed ingredients to unduly produce undesirable side-products. Preferably, the electrolyte can be mixed with the animal feed ingredients in a generally uniform manner. Electrolytes may be selected for their ability to help disperse or dissolve the food-coloring agent in the carrier and/or other animal feed ingredients to help ensure a more homogeneous dispersal of the coloring agent in the feed.

Some examples of electrolytes are salts (e.g. alkali metal salts, alkaline earth metal salts, halide salts, phosphates, sulphates, nitrates, etc.), sugars (e.g. sucrose, dextrose, fructose, mannose, etc.) and mixtures thereof. Preferred examples of electrolytes are sodium chloride, potassium chloride, magnesium chloride, magnesium sulphate, dextrose and mixtures thereof.

The electrolyte is present in the concentrate in a total amount of from about 2 wt % to about 20 wt % based on the weight of the concentrate. Preferably, the amount of electrolyte is from about 3 wt % to about 15 wt %. An amount of from about 4 wt % to about 10 wt % is of particular note.

In general, electrolytes help correct dehydration and electrolyte loss in animals during periods of stress caused by placement and/or movement of the animals. Standard electrolyte mixtures may be used in the preparation of the concentrate. For poultry and swine, for example, electrolyte mixtures listed in the Compendium of Medications for Poultry, Poultry Industry Council, Guelph, Ontario 2001 may be used.

The concentrate may contain other animal feed ingredients, particularly micro ingredients, if desired.

A physiologically acceptable carrier forms the balance of the concentrate. Physiologically acceptable carriers are capable of forming relatively homogeneous dispersions or solutions with the food-coloring agent and electrolytes, and do not cause undue adverse reactions in an animal ultimately eating the carrier. Carriers are preferably liquid. More preferably, the carrier is water. Preferably, the carrier is purified. Carriers may be purified by any known technique. For example, liquid carriers may be purified by distillation, reverse osmosis, filtration, ion exchange chromatography, etc. Liquid carriers may also serve to “activate” the coloring agent since some coloring agents require the presence of a liquid medium in order for the color to be homogeneously distributed throughout the resultant feed at the end of a milling process.

Concentrates may be prepared by mixing the coloring agent, electrolytes and carrier, together with any other desired ingredients, to form a generally homogeneous blend or solution.

Concentrates of the present invention are surprisingly advantageous in that they can be used at any number of feed processing steps to successfully prepare colored animal feed, especially on a large scale in a feed mill. Such versatility permits tailoring of feed processing to meet the needs of a particular operation.

### Colored Animal Feed and Processes for Preparation Thereof:

Animal feeds typically contain a wide variety of ingredients to provide a well-balanced diet. Feeds may also contain pharmaceutical and/or nutraceutical ingredients to provide enhanced health for the animals. The nature and proportion of the ingredients in the feed depend on many factors, for example, the type of animal, the age of the animal, nutritional requirements of the animal, individual feed producer preference and the cost of ingredients. Feed compositions may change from week to week due to such factors. Concentrates of the present invention may be used to produce colored feed of any composition.

Concentrates of the present invention are particularly advantageous in preparing colored pre-starter and starter feeds. Preferably, concentrates are used to produce feed for swine and poultry (e.g. chickens (layers, broilers, roasters, etc.) and turkeys). Concentrates are more particularly advantageous for preparing colored pre-starter and starter feeds for poultry and swine, especially poultry.

A typical feed contains macro ingredients, micro ingredients and liquid ingredients. Macro ingredients are typically used in a feed milling process in relatively large amounts and in dry form. Micro ingredients are typically used in relatively small amounts and in dry form. Macro ingredients may include, for example, grains (e.g. wheat, barley, canola, oats, flax, etc.), rolled corn, soya bean meal, protein meals of various types, some minerals sources, fillers, etc. Micro ingredients may include, for example, vitamins, some minerals, enzymes, amino acids, salts, antibiotics, probiotics, organic acids, buffers, etc. Liquid ingredients may include, for example, fats, greases, methionine, etc. Feed compositions are well within the ability of one skilled in the art to produce and the exact feed composition produced by any one feed supplier is often proprietary.

In a typical feed milling process, the various ingredients are stored in tanks and fed through feed lines to a main mixing tank. Some of the ingredients, for example the micro ingredients, may be pre-mixed in batches and then fed to a main mixer. Other ingredients, for example grains, may be ground before being fed into the mixer. Other pre-mixing processing steps may be used as desired or required. A carrier, for example water, may be used when needed to ensure that ingredients are carried into and mixed in the mixer. The ingredients may be mixed in the main mixer, preferably in a batch of 0.5-3 metric tonnes, to form a mash. The mash is pelletized, and expanded if desired. Pellets are then distributed into containers for bulk shipping. The mill is flushed after each feed order is made in compliance with Hazard Analysis Critical Control Points (HACCP) or like regulations.

Concentrates may be advantageously employed at any of a number of stages of the process to impart color to the feed. In one embodiment, the concentrate may be added to the mixer and mixed together where most of the other feed ingredients are mixed. The concentrate may be added to the mixer by any convenient means, for example by feeding from a storage tank or by pouring from a pail. In another embodiment, the concentrate may be added to the mash after mixing of the ingredients but before pelletizing, for example when the mash is expanded. In yet another embodiment, the concentrate may be added to the feed after pelletizing but before distribution into containers. The concentrate may be used in any amount that imparts sufficient color to the feed. For example, the concentrate is preferably used in an amount of from about 5-20 kg concentrate per 1000 kg feed (0.5-2 wt %), more preferably 7-15 kg per 1000 kg (0.7-1.5 wt %), for example 12 kg per 1000 kg (1.2 wt %).

In still yet another embodiment, the concentrate may be applied to feed in a barn or other animal feeding location. Preferably, the concentrate is diluted with an appropriate amount of diluent and applied directly to the feed. The diluent is preferably the same as the carrier used in the concentrate (e.g. water). The volume ratio of diluent:concentrate is preferably in a range of from about 200:1 to about 10:1, more preferably from about 150:1 to about 25:1. Application may be accomplished by any suitable technique, for example, spraying, pouring, dipping, etc. Spraying is preferred as it permits more even application of the color. The colored animal feed is allowed to dry before providing the colored feed to the animals.

### Methods of Use of Colored Animal Feed:

Colored animal feed is useful for enhancing feed consumption by animals and for increasing weight gain of animals. It is believed that the color attracts animals to the feed thereby encouraging them to eat more. This increases the likelihood of survival of the animal as well as overall weight gain of the animal.

Colored animal feed has been found to be particularly useful for new born and young animals. Particularly in the first 7 days of the animal's life, a small increase in weight will lead to better survivability and a much heavier shipping weight. This increases profitability of the animal growing operation. Therefore, enhancing feed consumption and increasing weight gain in the first 7 days is particularly important. Colored animal feed prepared in accordance with the present invention is particularly useful in the first 7 days of the animal's life.

Colored animal feed prepared in accordance with the present invention is particularly useful for enhancing feed consumption and weight gain of poultry and swine, more particularly of poultry. Poultry includes, for example, chickens (e.g. layers, broilers, roasters, etc.) and turkeys.

In respect of broiler chickens, for example, it has been shown in the art that anatomic changes in the digestive tract during the first days of life are remarkable. Broilers achieve a maximum relative weight of the digestive organs when they are between 3 and 8 days of age. The highest increase in volume of villi in the duodenum occurs when the birds are 4 days old and in the jejunum and ileum when they are 10 days old. If the birds don't achieve the maximum development of the villi in the duodenum in the first week and the jejunum and ileum in the second week, they are likely to have difficulty in developing good digestion and absorption capacities during their lives.

For optimal results, all other factors that affect the health of the animals should be controlled to industry standard. These include, for example, ventilation, cleanliness of living area, feeder placement, availability of fresh water, temperature, humidity, light, etc. Such factors are well known to one skilled in the art.

Further features of the invention will be described or will become apparent in the course of the following detailed description.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a schematic diagram of a feed milling operation; and,

FIG. 2 shows results for the effect on weight gain of broiler chicks of red colored feed prepared by a spray method.

### DETAILED DESCRIPTION OF PREFERRED EMBODIMENTS

### Example 1

### Preparation of Concentrates

A concentrate (12 kg) for coloring feed red was prepared by mixing the ingredients listed in Table 1 in a pail until a homogeneous mixture was formed:

TABLE 1

| Ingredient | Amount (g) | Purpose |
|---|---|---|
| FD & C Red #40 dye | 500.0 | Red colorant |
| Sodium chloride | 300.00 | Electrolyte |
| Potassium chloride | 15.0 | Electrolyte |
| Magnesium chloride | 7.5 | Electrolyte |
| Magnesium sulphate | 7.5 | Electrolyte |
| Dextrose | 400.0 | Electrolyte |
| Distilled water | 10,770.0 | Carrier |
| Total: | 12,000.0 | |

### Example 2

### Feed Compositions

A suitable red colored broiler chicken starter feed composition is provided in Table 2. This composition may be prepared in a feed mill in accordance with the process described in Example 3 below.

Limestone is a source of calcium. Mono-Dical Ca16/P21 is a source of phosphate. Alimet is a source of methionine. FF Broiler Micro Premix is a mixture of vitamins and minerals. Soda bicarb is sodium bicarbonate acting a pH buffer. Col-CI70 is choline chloride. Corn-soy enzyme is a mixture of glucanase and xylanase.

TABLE 2

| Ingredient | Amount (kg) |
|---|---|
| Corn Fine Rolled 8.0% CP | 494.37 |
| Soya Bean Meal (SBM) 47.5% CP | 123.45 |
| Canola Meal 37% CP | 100.00 |
| Meat and Bone Meal 50% CP | 100.00 |
| Wheat HRS Western 13% CP | 75.00 |
| Wheat Shorts 16% CP | 71.60 |
| Concentrate of Example 1 | 12.00 |
| Poultry Fat | 10.00 |
| Limestone B2 Grade | 4.10 |
| Salt white mixing | 2.40 |
| Mono-Dical Ca16/P21 | 2.00 |
| Alimet 88% | 1.68 |
| FF Broiler Micro (1 kg) Premix | 1.25 |
| Lysine-HCl | 0.75 |
| Soda bicarb - BP | 0.50 |
| Copper sulphate (25) | 0.40 |
| Chol-Cl70 | 0.30 |
| Corn-soy enzyme | 0.20 |
| Total: | 1000.00 |

### Example 3

### Process for Preparing Feed Compositions

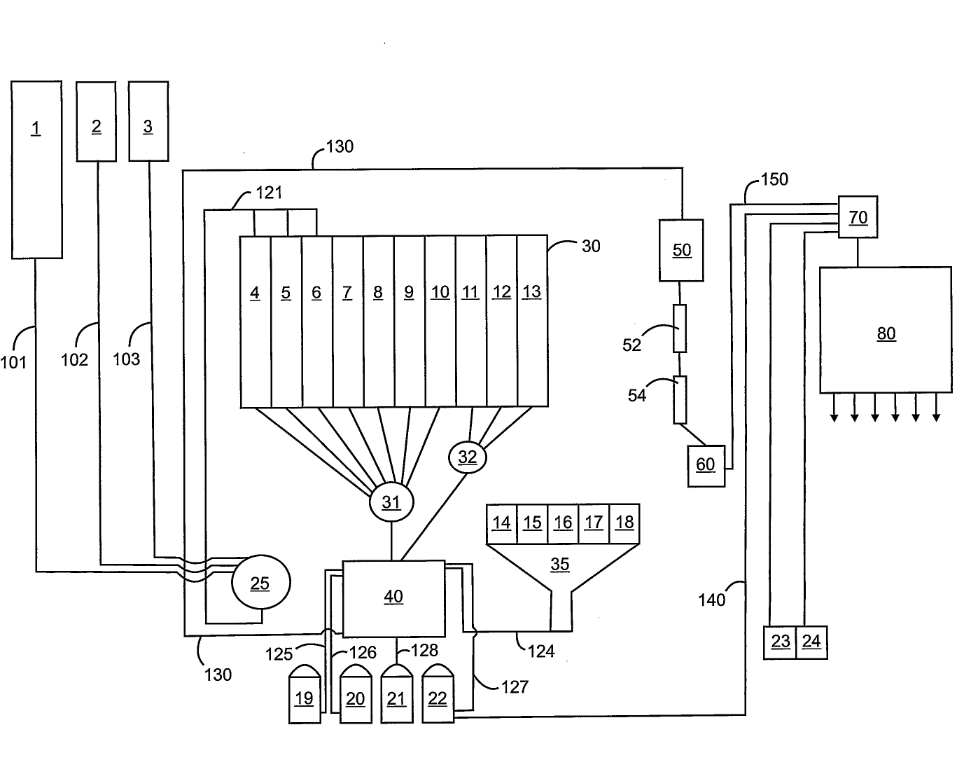

Referring to FIG. 1, the composition as described in Example 2 may be prepared in a feed mill as follows.

Corn, wheat HRS and wheat screenings are stored in external bins 1,2,3 respectively and fed to grinder 25 through lines 101,102,103 respectively where they are ground separately. Ingredients from grinder 25 are fed through line 121 and distributed to bins 4,5,6 in central storage area 30 of the feed mill where each ground ingredient is stored separately. Soya bean meal, canola meal, wheat shorts and meat and bone meal are stored in bins 7,8,9,10 respectively in central storage area 30. Limestone, salt and mono dical are stored in bins 11,12,13 respectively in central storage area 30. FF Broiler Premix, lysine, soda bicarb and copper sulphate are stored in bins 14,15,16,17 respectively. Another micro ingredient may be stored in bin 18, if desired. Barrels 23,24 for storing, respectively, corn-soy enzyme and phytase, if desired, are proximal to the micro ingredients. The concentrate of Example 1 is stored in tank 19, Alimet in tank 20, choline chloride in tank 21 and poultry fat in tank 22.

Dry ingredients in central storage area 30 are fed in the amounts listed in Table 2 on to scales 31,32 and then to main mixer 40. Micro ingredients are weighed on micro scale 35 and then fed to mixer 40 through line 124. Liquid ingredients in tanks 18,19,20,21 are fed into mixer 40 through lines 125,126,127,128.

Mixing of the ingredients in mixer 40 produces a red colored mash which is fed through line 130 to conditioner 50. Steam and water added at the conditioner intensifies the red color. The mash is then fed to expander 52 and pelletizer 54 where red colored pellets are formed from the mash. Expander 52 improves pellet quality, improves nutrient digestibility and reduces microbial levels. Red colored pellets are transferred from pelletizer 54 to cooler 60 and then through line 150 to post pelleting application system 70. Fat from tank 22 through line 140, corn-soy enzyme from barrel 23 and phytase, if desired, from barrel 24 are applied to the pellets at post pelleting application system 70. From the post pelleting application system finished feed is transferred to bins in bulk shipping storage area 80. Bulk feed from bulk shipping storage area 80 may be loaded into trucks, rail cars, shipping containers, etc.

### Example 4

### Methods of Use of Colored Feed

The effect of red colored feed on weight gain of broiler chicks in an industrial scale setting was examined.

### Spray Method:

A sprayable red colored dye solution was prepared by mixing 50 ml of a 15% (w/v) concentrate solution of red dye with 7 litres of distilled water to form a homogeneous solution. A broiler chicken starter feed having a composition as listed in Table 3 was prepared in a process similar to the one described in Example 3.

TABLE 3

| Ingredient | Amount (kg) |
|---|---|
| Corn Fine Rolled 8.0% CP | 506.37 |
| Soya Bean Meal (SBM) 47.5% CP | 123.45 |
| Canola Meal 37% CP | 100.00 |
| Meat and Bone Meal 50% CP | 100.00 |
| Wheat HRS Western 13% CP | 75.00 |
| Wheat Shorts 16% CP | 71.60 |
| Poultry Fat | 10.00 |
| Limestone B2 Grade | 4.10 |
| Salt white mixing | 2.40 |
| Mono-Dical Ca16/P21 | 2.00 |
| Alimet 88% | 1.68 |
| FF Broiler Micro (1 kg) Premix | 1.25 |
| Lysine-HCl | 0.75 |
| Soda bicarb - BP | 0.50 |
| Copper sulphate (25) | 0.40 |
| Chol-Cl70 | 0.30 |
| Corn-soy enzyme | 0.20 |
| Total: | 1000.00 |

The feed was spread on paper in brooding areas on 16 floors of six barns. On each floor in each barn the feed was spread evenly on the paper to provide about 50-70 grams of feed per bird (about 3 days supply). On 10 floors of the six barns, the feed was sprayed evenly with the sprayable red colored dye solution described above using a backpack sprayer. Each barn had one floor of feed that remained uncolored. The dye solution was allowed to dry and the barn conditions between each floor in a barn were optimized and standardized in accordance with Horizon Poultry Excellence Program Standard Operating Procedures. On each floor, newly hatched broiler chicks were tipped onto the paper and allowed to feed themselves. From Day 3 onward, birds on all floors in all barns were fed the same feed containing no red colored dye.

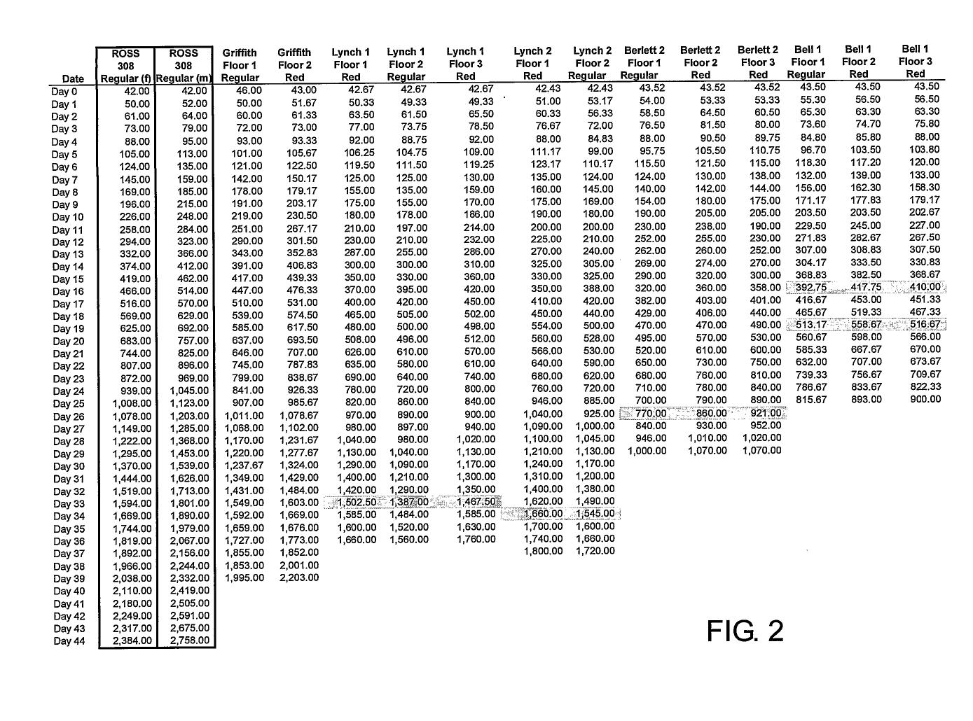

Bird weights were taken three times per day from six different areas on each floor each day. For each weighing, 10 birds were randomly selected from each of the six areas on each floor of each barn. Average daily weights were calculated for each floor of each barn. Results are illustrated in FIG. 2 and weights at Day 0, Day 7 and Day 20 are summarized in Table 4.

TABLE 4

| | Feed | Day 0 | Day 7 | Weight | Day 20 | Weight |
|---|---|---|---|---|---|---|
| | Color | Weight (g) | Weight (g) | gain (g) | Weight (g) | gain (g) |
| A | Regular | 46.00 | 142.00 | 96.00 | 637.00 | 591.00 |
| B | Red | 43.00 | 150.17 | 107.17 | 693.50 | 650.50 |
| C | Red | 42.67 | 125.00 | 82.33 | 508.00 | 465.33 |
| D | Regular | 42.67 | 125.00 | 82.33 | 496.00 | 453.33 |
| E | Red | 42.67 | 130.00 | 87.33 | 512.00 | 469.33 |
| F | Red | 42.43 | 135.00 | 92.57 | — | — |
| G | Regular | 42.43 | 124.00 | 81.57 | — | — |
| H | Regular | 43.52 | 124.00 | 80.48 | — | — |
| I | Red | 43.52 | 130.00 | 86.48 | — | — |
| J | Red | 43.52 | 138.00 | 94.48 | — | — |
| K | Regular | 43.50 | 132.00 | 88.50 | — | — |
| L | Red | 43.50 | 139.00 | 95.50 | — | — |

| | Barn | Floor | Sex of Bird |
|---|---|---|---|
| A | Griffith | Floor 1 | pullets |
| B | Griffith | Floor 2 | pullets |
| C | Lynch 1 | Floor 1 | cockerals |
| D | Lynch 1 | Floor 2 | cockerals |
| E | Lynch 1 | Floor 3 | cockerals |
| F | Lynch 2 | Floor 1 | pullets |
| G | Lynch 2 | Floor 2 | pullets |
| H | Berlett 2 | Floor 1 | cockerals |
| I | Berlett 2 | Floor 2 | cockerals |
| J | Berlett 2 | Floor 3 | cockerals |
| K | Bell 1 | Floor 1 | pullets |
| L | Bell 1 | Floor 2 | pullets |

Inspection of FIG. 2 and Table 4 shows that broiler chicks, whether male (cockerals) or female (pullets), consistently gain more weight after 7 days when fed red colored starter feed rather than regular, uncolored starter feed of the same nutrient composition. The increased weight gain in the first 7 days was magnified over 20 days even though all birds received the same feed from Day 3 onward.

FIG. 2 also provides idealized performance data for male (cockerel) and female (pullet) Ross 308 broilers. Weight gain profiles for broiler chicks fed red colored starter feed compare favourably with the idealized data. Data collected from the Griffith barn shows weight gains exceeding the idealized data for female broiler chicks fed red colored feed. In FIG. 2, the shaded numbers are from days that weights were not taken due to either extreme heat or other emergencies on the farm. The data entered for these dates have been calculated by taking the (previous day+following day)/2.

### Milling Method:

Regular and red colored broiler chicken starter feeds were prepared in separate milling processes, both processes following a procedure similar to the one described in Example 3. For the red colored feed, a concentrate as described in Example 1 was added in the main mixer by pouring 12 kg of the concentrate into the mixer using a pail. The compositions of the regular and red colored feeds are provided in Table 5.

TABLE 5

| | Regular Feed | Red Colored Feed |
|---|---|---|
| Ingredient | Amount (kg) | Amount (kg) |
| Corn Fine Rolled 8.0% CP | 506.37 | 494.37 |
| Soya Bean Meal (SBM) 47.5% CP | 123.45 | 123.45 |
| Canola Meal 37% CP | 100.00 | 100.00 |
| Meat and Bone Meal 50% CP | 100.00 | 100.00 |
| Wheat HRS Western 13% CP | 75.00 | 75.00 |
| Wheat Shorts 16% CP | 71.60 | 71.60 |
| Poultry Fat | 10.00 | 10.00 |
| Limestone B2 Grade | 4.10 | 4.10 |
| Salt white mixing | 2.40 | 2.40 |
| Mono-Dical Ca16/P21 | 2.00 | 2.00 |
| Alimet 88% | 1.68 | 1.68 |
| FF Broiler Micro (1 kg) Premix | 1.25 | 1.25 |
| Lysine-HCl | 0.75 | 0.75 |
| Soda bicarb - BP | 0.50 | 0.50 |
| Copper sulphate (25) | 0.40 | 0.40 |
| Chol-Cl70 | 0.30 | 0.30 |
| Corn-soy enzyme | 0.20 | 0.20 |
| Red concentrate of Example 1 | 0.00 | 12.00 |
| Total: | 1000.00 | 1000.00 |

The feed was spread on paper in brooding areas on five floors of two barns. On each floor in each barn feed was spread evenly on the paper to provide about 50-70 grams of feed per bird (about 3 days supply). Each barn had one floor of regular feed. One barn had two floors of red colored feed and the other barn had one floor of red colored feed. The barn conditions between each floor in a barn were optimized and standardized in accordance with Horizon Poultry Excellence Program Standard Operating Procedures. On each floor, newly hatched cockerel broiler chicks were tipped onto the paper and allowed to feed themselves. From Day 3 onward, birds on all floors in all barns were fed the same uncolored feed.

Bird weights were taken three times per day from six different areas on each floor each day. For each weighing, 10 birds were randomly selected from each of the six areas on each floor of each barn. Average daily weights were calculated for each floor of each barn. Results are summarized in Table 6.

TABLE 6

| | Smith 1 | Smith 1 | Smith 1 | Smith 2 | Smith 2 |
|---|---|---|---|---|---|
| | Floor 1 | Floor 2 | Floor 3 | Floor 1 | Floor 2 |
| | Regular | Red | Red | Regular | Red |
| | Weight (g) | Weight (g) | Weight (g) | Weight (g) | Weight (g) |
| Day 0 | 46.00 | 46.00 | 46.00 | 42.00 | 42.00 |
| Day 1 | 54.00 | 55.50 | 54.00 | 53.33 | 53.17 |
| Day 2 | 65.00 | 67.00 | 66.67 | 63.50 | 64.50 |
| Day 3 | 77.50 | 81.50 | 81.17 | 74.83 | 75.17 |
| Day 4 | 90.83 | 96.17 | 95.67 | 90.67 | 93.00 |
| Day 5 | 107.17 | 112.00 | 111.50 | 98.17 | 104.67 |
| Day 6 | 117.50 | 123.83 | 127.00 | 119.83 | 117.17 |
| Day 7 | 136.00 | 143.00 | 147.17 | 135.50 | 137.00 |
| Day 8 | 152.75 | 161.25 | 162.25 | | |
| Day 9 | 176.50 | 195.75 | 184.25 | | |
| Day 10 | 195.00 | 215.50 | 208.25 | | |

In both barns, birds fed red colored starter feed for the first 3 days of life showed increases in weight at 7 days over birds fed uncolored feed. The results demonstrate that a milling process using a concentrate of the present invention is effective at providing bulk colored feed that can improve weight gain in an animal.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features and sub-combinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

1. A concentrate for preparing a colored animal feed comprising:
from about 1 wt % to about 15 wt % of a physiologically acceptable feed consumption enhancing food-coloring agent compatible with animal feed ingredients;
from about 2 wt % to about 20 wt % of a physiologically acceptable electrolyte compatible with animal feed ingredients; and
the balance, a physiologically acceptable carrier,
all weights based on weight of the concentrate.

2. The concentrate of claim 1, wherein the food-coloring agent is a red or blue food-coloring agent.

3. The concentrate of claim 1, wherein the food-coloring agent is a red food-coloring agent.

4. The concentrate of claim 1, wherein the carrier comprises water.

5. The concentrate of claim 1, wherein the electrolyte is a mixture of two or more electrolytes.

6. A process for preparing colored animal feed, comprising the steps of:
providing a concentrate according to claim 1;
mixing the concentrate with animal feed ingredients; and
further processing the mixture into colored animal feed.

7. The process of claim 6, wherein the animal feed ingredients are mixed in a mixer to form a mash, and mixing of the concentrate is performed in the mixer together with the animal feed ingredients to form a colored mash.

8. The process of claim 6, wherein the animal feed ingredients are mixed in a mixer to form a mash, the mash is pelletized to form pellets, and the concentrate is mixed with the mash after the mash is formed but before the mash is pelletized.

9. The process of claim 6, wherein the animal feed ingredients are mixed in a mixer to form a mash, the mash is pelletized to form pellets, and the concentrate is mixed with the pellets to form colored pellets.

10. The process of claim 7, further comprising expanding the mash.

11. Colored animal feed comprising:
about 30-40 wt % corn,
about 10-30 wt % wheat,
about 10-15 wt % soya bean,
about 5-10 wt % canola,
about 0.05-0.25 wt % of a physiologically acceptable mineral,
about 0.01-0.05 wt % of a physiologically acceptable enzyme, a physiologically acceptable feed consumption enhancing food-coloring agent and a physiologically acceptable electrolyte,
all weights based on weight of the animal feed.

12. The feed of claim 11, wherein the food-coloring agent is a red or blue food-coloring agent.

13. The feed of claim 11, wherein the food-coloring agent is a red food-coloring agent.

14. Colored animal feed comprising:
about 30-40 wt % corn,
about 10-30 wt % wheat,
about 10-15 wt % soya bean,
about 5-10 wt % canola,
about 0.05-0.25 wt % of a physiologically acceptable mineral,
about 0.01-0.05 wt % of a physiologically acceptable enzyme, and
0.5-2 wt % of a concentrate according to claim 1.

15. A method for enhancing consumption of animal feed by an animal, comprising the steps of:
mixing a concentrate according to claim 1 with a physiological acceptable diluent to form a mixture,
applying the mixture to animal feed to form colored animal feed,
drying the colored animal feed,
providing the colored animal feed to the animal, and
allowing the animal to eat the colored animal feed.

16. The method of claim 15, wherein the mixture has a diluent:concentrate volume ratio of about 200:1.

17. A method of increasing weight gain of an animal, comprising the steps of:
obtaining a colored animal feed prepared from a concentrate according to claim 1, and
feeding the colored animal feed to the animal.

18. The method of claim 17, wherein the colored animal feed is fed to the animal for the first 7 days of the animal's life.

19. The method of claim 17, wherein the animal is swine or poultry.

20. The method of claim 17, wherein the animal is a chicken.
